(19) United States
(12) Patent Application Publication
(10) Pub. No.: US 2008/0278414 A1
(43) Pub. Date: Nov. 13, 2008

(54) Plasma display device and driving method thereof

(76) Inventor: Hyun Kim, Suwon-si (KR)

Correspondence Address: ROBERT E. BUSHNELL, 1522 K STREET NW, SUITE 300, WASHINGTON, DC, 20005-1202, US

(21) Appl. No.: 12/081,133

(22) Filed: Apr. 10, 2008

(30) Foreign Application Priority Data
May 8, 2007 (KR) 10-2007-0044549

(51) Int. Cl. G09G 3/28

(52) U.S. Cl. 345/60; 345/67; 345/204

(57) ABSTRACT

A device and method for driving a plasma display including a first electrode, a second electrode, and a third electrode crossing the first and second electrodes, and a gap between the first and second electrodes is wider than a gap between the first and third electrodes. In this method, a first voltage is applied to the first electrode during a first period of a sustain period, and a second voltage that is lower than the first voltage is applied to the second electrode and a third voltage that is lower than the second voltage is subsequently applied to the second electrode during at least a part of the first period.

### CLAIM OF PRIORITY

This application makes reference to, incorporates the same herein, and claims all benefits accruing under 35 U.S.C.§119 from an application for PLASMA DISPLAY DEVICE AND DRIVING METHOD THEREOF earlier filed in the Korean Intellectual Property Office on 8 May 2007 and there duly assigned Serial No. 10-2007-0044549.

### BACKGROUND OF THE INVENTION

1. Field of the Invention

The present invention relates to a plasma display and a driving method thereof.

2. Description of the Related Art

A plasma display is a flat panel display that uses plasma generated by gas discharge to display characters or images. It includes, depending on its size, more than several scores to millions of discharge cells (hereinafter, also referred to as “cells”) arranged in a matrix pattern.

In this case, a narrow discharge gap of 60 to 120 μm is formed between a scan electrode Y and a sustain electrode X in a discharge cell of the plasma display. In this plasma display, since a discharge space in the discharge cell is small, it is difficult to increase luminous efficiency. Accordingly, studies for increasing discharge efficiency by increasing the length between the electrodes and generating a long gap discharge have been actively performed. One of them is a technique using positive column discharge characteristics. In this technique, a large discharge gap that is more than 250 μm is formed between the scan electrode Y and the sustain electrode X to generate a positive column discharge. However, since brightness saturation occurs as a frequency increases in a configuration in which the gap between the scan electrode Y and the sustain electrode X is large, the efficiency decreases. That is, in a long gap configuration in which the gap between the scan electrode Y and the sustain electrode X is larger than the gap between the scan electrode Y and the address electrode A, when a normal sustain pulse is applied to the scan electrode and the sustain electrode, the efficiency is high in a low frequency but it problematically decreases in a radio frequency.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a plasma display for improving efficiency and a driving method thereof.

According to an exemplary embodiment of the present invention, in a method for driving a plasma display including a first electrode, a second electrode, and a third electrode crossing the first and second electrodes, a gap between the first and second electrodes is wider than a gap between the first and third electrodes, a first voltage is applied to the first electrode during a first period of a sustain period, and a second voltage that is lower than the first voltage is applied to the second electrode and a third voltage that is lower than the second voltage is subsequently applied to the second electrode during at least a part of the first period.

In addition, according to another exemplary embodiment of the present invention, a plasma display includes a plasma display panel (PDP) and a driver. The PDP includes a first electrode, a second electrode, and a third electrode crossing the first and second electrodes, and a gap between the first and second electrodes is wider than that between the second and third electrodes. The driver drives the PDP. In this case, the driver generates a first voltage difference between the first and second electrodes and generates a second voltage difference between the first and second electrodes during a first period of a sustain period, and the second voltage difference is greater than the first voltage difference.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a diagram of a plasma display according to an exemplary embodiment of the present invention.

FIG. 2 is a partial top plan view of a plasma display (PDP) shown in FIG. 1.

FIG. 3 is a cross-sectional view along a line II-II′ shown in FIG. 2.

FIG. 4 is a diagram representing a driving waveform of the plasma display according to the exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout this specification and the claims that follow, when it is described that an element is “coupled” to another element, the element may be “directly coupled” to the other element or “electrically coupled” to the other element through a third element. In addition, unless explicitly described to the contrary, the word “comprise” and variations such as “comprises” or “comprising”, will be understood to imply the inclusion of stated elements but not the exclusion of any other elements.

In addition, wall charges mentioned in the following description mean charges formed and accumulated on a wall (e.g., a dielectric layer) close to an electrode of a discharge cell. The wall charges will be described as being “formed” or “accumulated” on the electrode, although the wall charges do not actually touch the electrodes. Further, a wall voltage is a potential difference formed on the wall of the discharge cell by the wall charges.

A plasma display according to an exemplary embodiment of the present invention and a driving method thereof will be described.

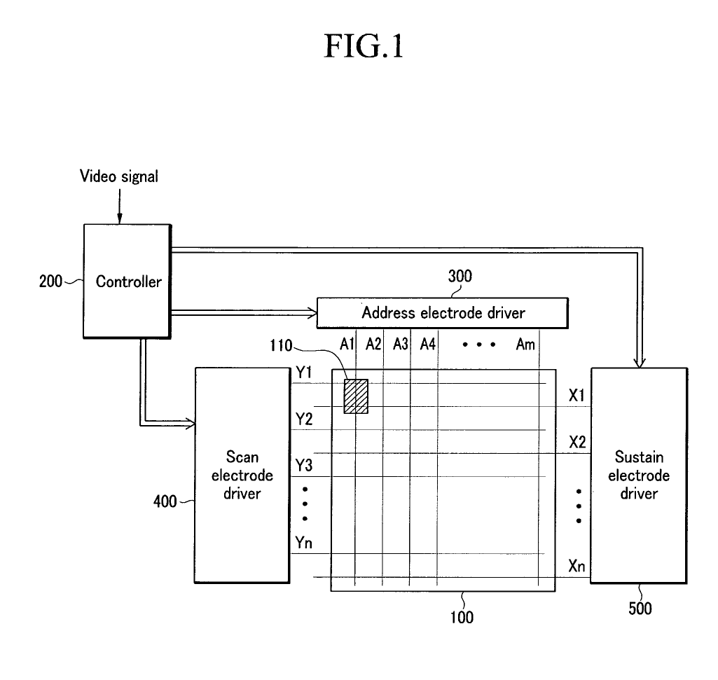

FIG. 1 is a diagram of the plasma display according to the exemplary embodiment of the present invention.

As shown in FIG. 1, the plasma display, according to the exemplary embodiment of the present invention, includes a plasma display panel (PDP) 100, a controller 200, an address electrode driver 300, a scan electrode driver 400, and a sustain electrode driver 500.

The PDP 100 includes a plurality of address electrodes A1 to Am extending in a column direction, and a plurality of sustain electrodes X1 to Xn and a plurality of scan electrodes Y1 to Yn extending in a row direction by pairs. The sustain electrodes X1 to Xn are formed in correspondence to the respective scan electrodes Y1 to Yn. In this case, a discharge space formed at a crossing region of the address electrodes A1 to Am and the sustain and scan electrodes X1 to Xn and Y1 to Yn forms a discharge cell 110 (hereinafter referred to as a “cell”). This is an exemplary structure of the PDP 100, and panels of other structures can be applied to the present invention.

The controller 200 receives a video signal from the outside to output an address electrode driving control signal, a sustain electrode driving control signal, and a scan electrode driving control signal. In addition, the controller 200 divides one frame into a plurality of subfields respectively having weight values.

The address electrode driver 300 receives the address electrode driving control signal from the controller 200 to apply a display data signal for selecting a desired discharge cell to the address electrodes A1 to Am.

The scan electrode driver 400 receives the scan electrode driving signal to apply a driving voltage to the scan electrodes Y1 to Yn. In addition, the scan electrode driver 400 according to the exemplary embodiment of the present invention applies a negative sub-voltage Vs1 to the scan electrodes Y1 to Yn during a sustain period.

The sustain electrode driver 500 receives the sustain electrode driving control signal from the controller 200 to apply a driving voltage to the sustain electrodes X1 to Xn. In addition, the sustain electrode driver 500 according to the exemplary embodiment of the present invention applies the negative sub-voltage Vs1 to the sustain electrodes X1 to Xn during the sustain period.

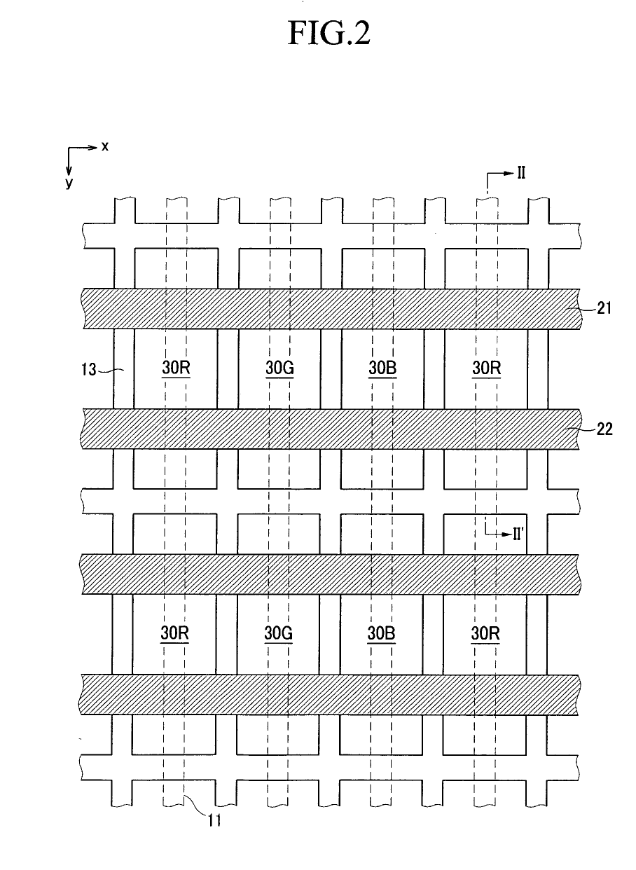

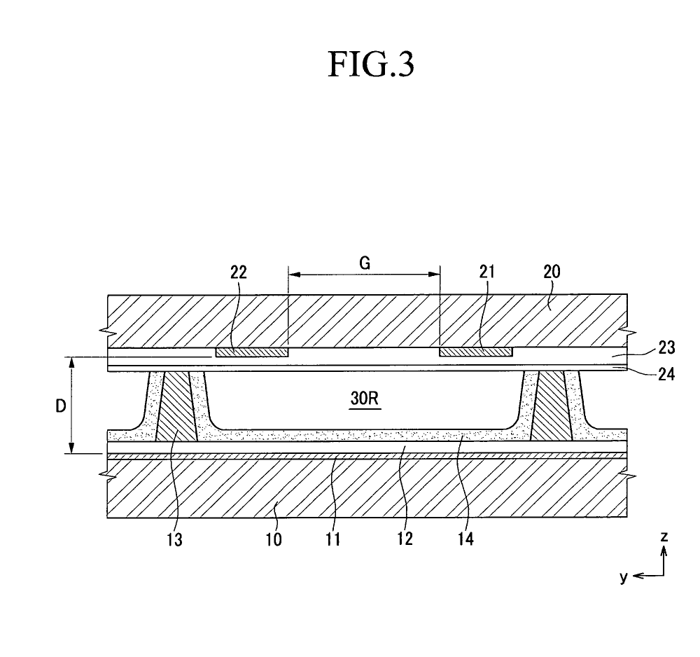

The PDP 100 according to the exemplary embodiment of the present invention will be described with reference to FIG. 2 and FIG. 3.

FIG. 2 is a partial top plan view of the PDP shown in FIG. 1, and FIG. 3 is a cross-sectional view along the line II-II′ shown in FIG. 2. As shown in FIG. 2 and FIG. 3, only one sustain electrode 21, one scan electrode 22, and one address electrode 11 among the plurality of sustain, scan, and address electrodes X1 to Xn, Y1 to Yn, and A1 to Am are illustrated.

FIG. 2 and as shown in FIG. 3, the PDP 100 includes a rear substrate 10 and a front substrate 20 that face to each other with a predetermined gap therebetween.

The address electrode 11 extends on the rear substrate 10 in a direction (i.e., a y-axis direction in FIG. 2 and FIG. 3), and a dielectric layer 12 is formed on the rear substrate 10 while covering the address electrode 11. The address electrode 11 is formed to be parallel with a neighboring address electrode 11 while having a predetermined gap therebetween. A barrier rib 13 is formed on the dielectric layer 12 in the y-axis direction and a direction perpendicularly crossing the y-axis direction (i.e., an x-axis direction in FIG. 2 and FIG. 3). The cell is partitioned as cells 30R, 30G, and 30B by the barrier ribs 13 in such a lattice formation. In addition, a phosphor layer 14 is formed on lateral sides of the barrier ribs 14 and on the dielectric layer 12. The red, green, and blue phosphor layers 14 are respectively formed in the cells 30R, 30G, and 30B to determine colors of the cells 30R, 30G, and 30B. Further, as shown in FIG. 2 and FIG. 3, although the barrier ribs 13 are formed as a lattice, they may be formed in a stripe pattern or in another closed pattern.

The sustain electrode 21 and the scan electrode 22 extend on the front substrate 20 in the x-axis direction. A transparent dielectric layer 23 and a protective layer 24 are formed on the front substrate 20 while covering the sustain electrode 21 and the scan electrode 22. The protective layer 24 may be formed of MgO that has a good secondary electron emission coefficient.

In addition, a gap G between the sustain and scan electrodes 21 and 22 is formed to be wider than a gap D between the address and scan electrodes 11 and 22, which is referred to as a “long gap configuration”. As described, when the electrode positioned on the cell 30R is formed in the long gap configuration and a sustain discharge is generated between the sustain and scan electrodes 21 and 22 during the sustain period, a positive column discharge is generated and luminous efficiency is increased.

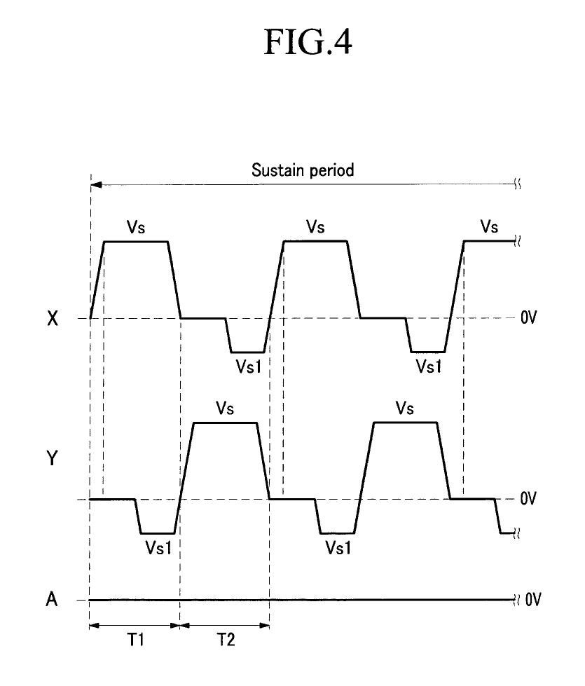

A driving waveform applied to the long gap configuration will be described with reference with FIG. 4.

FIG. 4 is a diagram representing the driving waveform of the plasma display according to the exemplary embodiment of the present invention. In FIG. 4, for better understanding and ease of description, only the sustain period is illustrated, and it will be described based on a cell formed by one scan electrode Y, one sustain electrode X, and one address electrode A. In addition, the scan, sustain, and address electrodes are respectively illustrated as Y, X, and A.

As shown in FIG. 4, during the sustain period, while maintaining the address electrode A at a reference voltage (0V in FIG. 4), the scan electrode driver 400 applies a sustain pulse alternately having a high level voltage (Vs in FIG. 4) and the reference voltage to the scan electrode Y a number of times corresponding to a weight value of a corresponding subfield. The sustain electrode driver 500 applies the sustain pulse to the sustain electrode X, and the sustain pulse applied to the sustain electrode has an opposite phase to the sustain pulse applied to the scan electrode Y.

According to the exemplary embodiment of the present invention, during the sustain period, a negative sub-voltage (Vs1 in FIG. 4) is applied after the reference voltage (0V in FIG. 4) is applied to the scan electrode Y or the sustain electrode X. That is, in the long gap configuration, since the negative sub-voltage Vs1 is applied for a predetermined period after the reference voltage 0V is applied, efficiency may not be reduced when a frequency increases. In addition, the negative sub-voltage Vs1 is applied to prevent luminance saturation caused as the frequency increases.

In further detail, during a first period T1 of the sustain period, after the high level voltage Vs is applied to the scan electrode Y and the reference voltage is applied to the sustain electrode X, the negative sub-voltage Vs1 that is narrower than a width of the sustain pulse is applied. Here, an absolute value of the negative sub-voltage Vs1 is lower than an absolute value of the high level voltage Vs. Since the negative sub-voltage Vs1 is applied to the sustain electrode X after a main discharge is generated, the scan and sustain electrodes Y and X have a voltage difference of (Vs−Vs1). Thereby, a larger amount of (+) wall charges are formed on the sustain electrode X compared to when the reference voltage 0V is applied to the sustain electrode X.

In addition, during a second period T2 of the sustain period, the reference voltage 0V is applied to the scan electrode Y, the high level voltage Vs is applied to the sustain electrode X, and the negative sub-voltage Vs1 that is narrower than the width of the sustain pulse is applied. In further detail, since the negative sub-voltage Vs1 is applied to the scan electrode Y after the main discharge is generated, the scan and sustain electrodes Y and X have a voltage difference of (Vs1−Vs). Thereby, the larger amount of (+) wall charges are formed on the scan electrode compared to when the reference voltage 0V is applied to the scan electrode Y.

The first and second periods T1 and T2 are repeatedly performed during the sustain period a number of times corresponding to the weight value of the corresponding subfield.

Accordingly, in the long gap configuration, since the amount of wall charges on the electrode to which the negative sub-voltage Vs1 is applied during the sustain period increases, a subsequent discharge may not be concentrated, and the efficiency may be improved.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

As described above, according to the exemplary embodiment of the present invention, since the negative sub-voltage is applied during the sustain period, the luminance saturation according to the frequency may be reduced to improve the luminous efficiency.

What is claimed is:

1. A method for driving a plasma display comprising a first electrode, a second electrode, and a third electrode crossing the first and second electrodes, the plasma display having a gap between the first and second electrodes that is wider than a gap between the first and third electrodes, the method comprising, in a sustain period:
during a first period, applying a first voltage to the first electrode; and
during at least a part of the first period, applying a second voltage that is lower than the first voltage to the second electrode and subsequently applying a third voltage that is lower than the second voltage to the second electrode.

2. The method of claim 1, further comprising:
during a second period subsequent to the first period, applying the first voltage to the second electrode; and
during at least a part of the second period, applying the second voltage to the first electrode and subsequently applying the third voltage to the first electrode.

3. The method of claim 2, further comprising
repeatedly performing the first and second periods a predetermined number of times.

4. The method of claim 1, further comprising, during the first period,
applying the third voltage to the second electrode after a main discharge is generated between the first and second electrodes.

5. The method of claim 1, wherein an absolute value of the third voltage is lower than that of the first voltage.

6. The method of claim 1, further comprising applying the second voltage to the third electrode during the sustain period.

7. The method of claim 6, wherein the second voltage is a ground voltage.

8. A plasma display comprising:
a plasma display panel (PDP) comprising a first electrode, a second electrode, a third electrode crossing the first and second electrodes, and a gap between the first and second electrodes that is wider than that between the second and third electrodes; and
a driver for driving the PDP,
wherein the driver generates a first voltage difference between the first and second electrodes and generates a second voltage difference between the first and second electrodes during a first period of a sustain period, and
the second voltage difference is greater than the first voltage difference.

9. The plasma display of claim 8, wherein the driver generates the first voltage difference between the first and second electrodes and generates the second voltage difference between the first and second electrodes during a second period that is subsequent to the first period, and the second voltage difference is greater than the first voltage difference.

10. The plasma display of claim 9, wherein the first and second periods are repeatedly performed a predetermined number of times.

11. A plasma display panel, comprising:
a first electrode;
a second electrode;
a third electrode crossing the first and second electrodes;
a first gap between the first and second electrodes;
a second gap between the second and third electrodes; and
a driver for driving the plasma display panel,
wherein said first gap is wider than said second gap,
wherein the driver generates a first voltage difference between the first and second electrodes and generates a second voltage difference between the first and second electrodes during a first period of a sustain period, and the second voltage difference is greater than the first voltage difference, and
wherein during said sustain period a positive column discharge occurs increasing luminous.
